(19) United States
(12) Patent Application Publication
(10) Pub. No.: US 2021/0129603 A1
(43) Pub. Date: May 6, 2021

(54) Wheel Pressure Adjustment Assembly

(71) Applicant: Anthony Wijeysooriya, Pittsburgh, PA (US)

(72) Inventor: Anthony Wijeysooriya, Pittsburgh, PA (US)

(21) Appl. No.: 16/670,478

(22) Filed: Oct. 31, 2019

(51) Int. Cl. B60C 23/10; B60C 23/00; B60C 23/04; B60C 29/00; B60C 29/06

(52) U.S. Cl. CPC B60C 23/10; B60C 23/001; B60C 23/041; B60C 29/005; B60C 29/06; B60C 23/0422

(57) ABSTRACT

A wheel pressure adjustment assembly includes a valve unit that is fluidly coupled to a vehicle wheel. The valve unit is actuatable in an open condition for passing air therethrough to deflate the vehicle wheel. The valve unit is actuatable in a closed condition for inhibiting air from passing therethrough to retain air pressure in the vehicle wheel at a selected pressure. The valve unit is actuatable into an inflating condition for passing air into the vehicle wheel. A compressor is coupled to the valve unit and the compressor is turned on when the valve unit is actuated into the inflating condition. In this way the compressor inflates the vehicle wheel.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

The disclosure relates to pressure adjustment device and more particularly pertains to a new pressure adjustment device for automatically inflating or deflating a vehicle wheel.

### (2) Description of Related Art including information disclosed under 37 CFR 1.97 and 1.98.

The prior art relates to pressure adjustment device.

### BRIEF SUMMARY OF THE INVENTION

An embodiment of the disclosure meets the needs presented above by generally comprising a valve unit that is fluidly coupled to a vehicle wheel. The valve unit is actuatable in an open condition for passing air therethrough to deflate the vehicle wheel. The valve unit is actuatable in a closed condition for inhibiting air from passing therethrough to retain air pressure in the vehicle wheel at a selected pressure. The valve unit is actuatable into an inflating condition for passing air into the vehicle wheel. A compressor is coupled to the valve unit and the compressor is turned on when the valve unit is actuated into the inflating condition. In this way the compressor inflates the vehicle wheel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a wheel pressure adjustment assembly according to an embodiment of the disclosure.

FIG. 2 is a right side phantom view of an embodiment of the disclosure.

FIG. 3 is a perspective in-use view of an embodiment of the disclosure.

FIG. 4 is a cross sectional view taken along line 4-4 of FIG. 3 of an embodiment of the disclosure.

FIG. 5 is a schematic view of an embodiment of the disclosure.

### DETAILED DESCRIPTION OF THE INVENTION

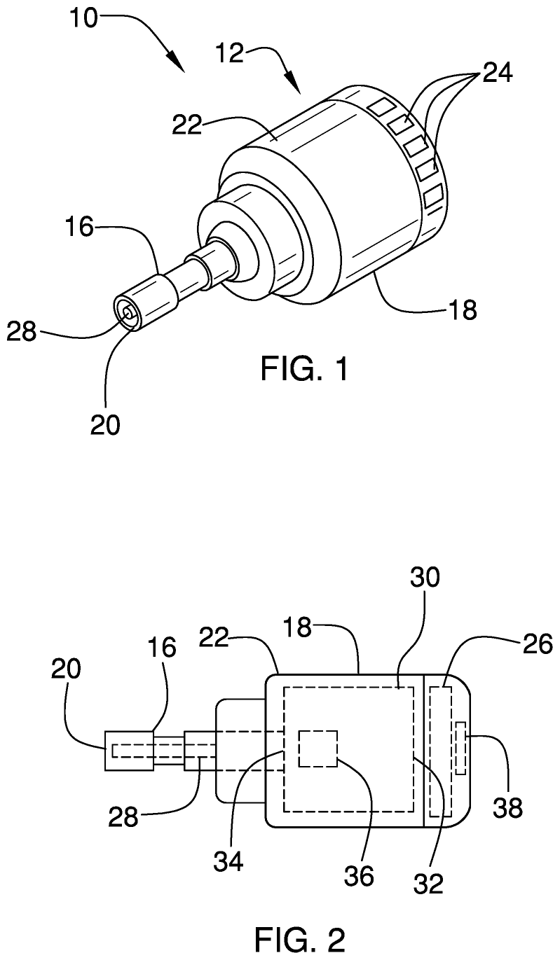

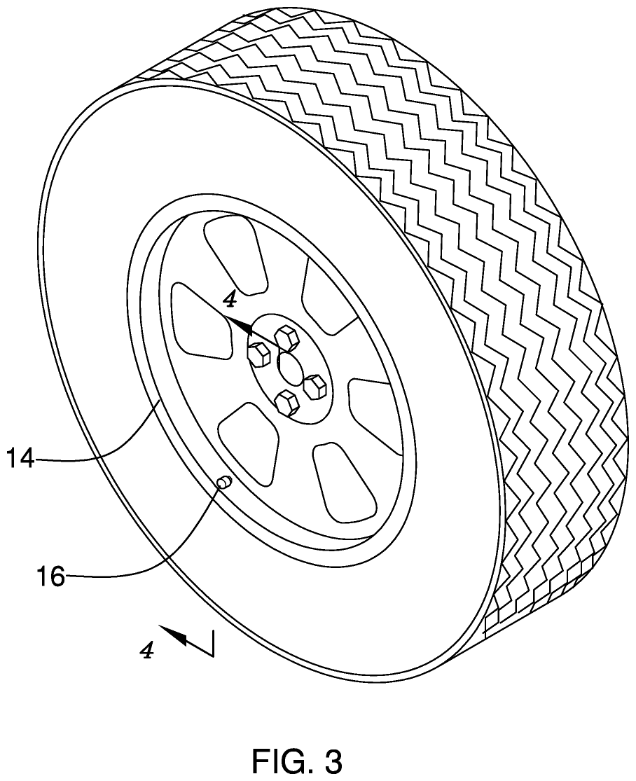

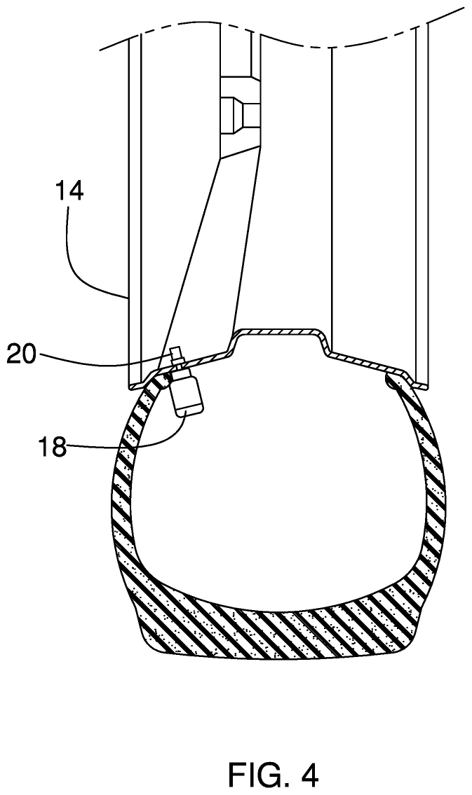

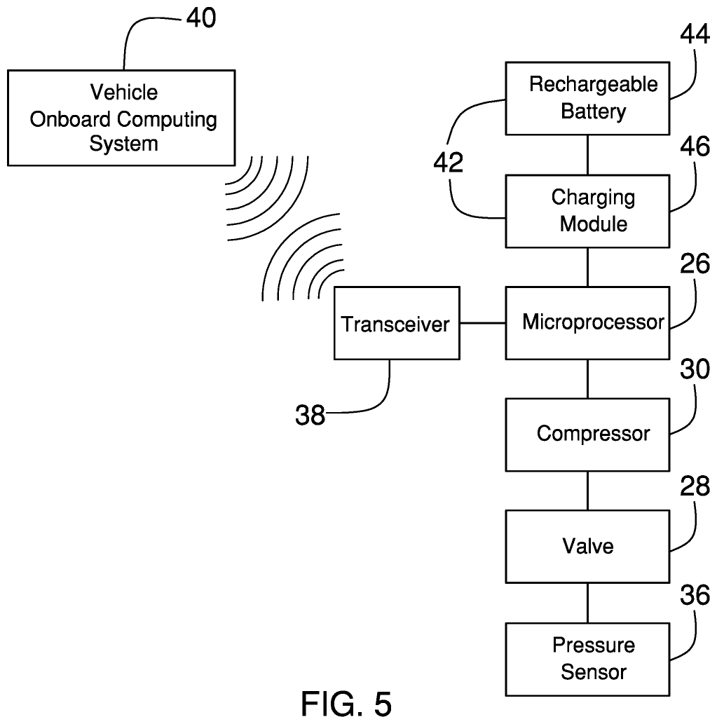

With reference now to the drawings, and in particular to FIGS. 1 through 5 thereof, a new pressure adjustment device embodying the principles and concepts of an embodiment of the disclosure and generally designated by the reference numeral 10 will be described.

As best illustrated in FIGS. 1 through 5, the wheel pressure adjustment assembly 10 generally comprises a valve unit 12 that is fluidly coupled to a vehicle wheel 14. The vehicle wheel 14 may include a tubeless tire on a passenger vehicle, a cargo vehicle, an off road vehicle or any other type of inflatable tire. The valve unit 12 is actuatable in an open condition for passing air therethrough to deflate the vehicle wheel 14. In this way the tire on the vehicle wheel 14 can be deflated for driving on sand or other similar material. The valve unit 12 is actuatable in a closed condition for inhibiting air from passing therethrough to retain air pressure in the tire on the vehicle wheel 14 at a selected pressure.

The valve unit 12 includes a stem 16 and a housing 18. The stem 16 has a distal end 20 with respect to the housing 18, the distal end 20 is open and the stem 16 is hollow. The stem 16 is coupled to the vehicle wheel 14 having the housing 18 being positioned within the vehicle wheel 14 and having the distal end 20 being exposed. The housing 18 has an outer wall 22 and the outer wall 22 has a vent 24 extending into an interior of the housing 18. The stem 16 may comprise a tire inflation stem of any conventional design for accommodating existing vehicle wheels.

The valve unit 12 includes a control circuit 26 that is coupled to the housing 18. The control circuit 26 receives a deflate input, an inflate input and an off input. A valve 28 is movably positioned in the stem 16 of the valve unit 12 and the valve 28 is electrically coupled to the control circuit 26. The valve 28 is fluidly coupled between the distal end 20 of the stem 16 and the vent 24 in the outer wall 22 of the housing 18. The valve 28 is actuated into an open position when the control circuit 26 receives the deflate input. In this way air in the vehicle wheel 14 passes outwardly through the distal end 20 of the stem 16 for deflating the tire on the vehicle wheel 14. The valve 28 is actuated into a closed position when the control circuit 26 receives the off input to inhibit air in the tire on the vehicle wheel 14 from passing outwardly through the distal end 20. The valve 28 may be an electronically controlled air valve or the like.

A compressor 30 is positioned in the housing 18 and the compressor 30 is electrically coupled to the control circuit 26. The compressor 30 has an input 32 and an output 34. The output 34 is in fluid communication with the vent 24 in the outer wall 22 of the housing 18 and the input 32 is in fluid communication with the valve 28. The compressor 30 urges air inwardly through the input 32 and outwardly through the output 34 when the compressor 30 is turned on. The compressor 30 is turned on when the control circuit 26 receives the inflate input. Additionally, the valve 28 is urged into the open position by air pressure when the compressor 30 is turned on to inflate the vehicle wheel 14. The compressor 30 may be a miniaturized, electronic compressor 30 that has an output capacity sufficient to inflate a tire on the vehicle wheel 14 to the tire manufacturer's recommended air pressure.

A pressure sensor 36 is provided and the pressure sensor 36 is positioned in the housing 18. Additionally, the pressure sensor 36 is electrically coupled to the control circuit 26. The pressure sensor 36 is in fluid communication with the valve 28 to sense air pressure within the tire on the vehicle wheel 14. The pressure sensor 36 may be an electronic air pressure sensor or the like.

A transceiver 38 is provided and the transceiver 38 is positioned in the housing 18. The transceiver 38 is electrically coupled to the control circuit 26. The transceiver 38 is in wireless communication with an electronic control system 40 of the vehicle. The electronic control system 40 of the vehicle may include a touch screen positioned within the vehicle, a computer and any other type of user interface commonly employed in motor vehicles. Additionally, controls may be positioned within the cabin of the vehicle for inflating and deflating the vehicle wheel 14.

The control circuit 26 receives the inflate input when a driver of the vehicle actuates the electronic control system 40 to inflate the tire on the vehicle wheel 14. Additionally, the control circuit 26 receives the deflate input when the driver actuates the electronic control system 40 to deflate the tire on the vehicle wheel 14. The control circuit 26 receives the off input when the driver actuates the electronic control system 40 to retain the tire on the vehicle wheel 14 at the current air pressure. The transceiver 38 communicates the air pressure sensed in the vehicle wheel 14 to the electronic control system 40 for informing the driver of the air pressure within the tire on the vehicle wheel 14. Moreover, the transceiver 38 may be a radio frequency transceiver or the like and the transceiver 38 may employ a LAN signal.

A power supply 42 is coupled to the housing 18 and the power supply 42 is electrically coupled to the control circuit 26. The power supply 42 comprises at least one battery 44 that is positioned in the housing 18. The at least one battery 44 is electrically coupled to the control circuit 26. The power supply 42 comprises a charger 46 that is coupled to the outer wall 22 of the housing 18 such that the charger 46 is exposed. The charger 46 is electrically coupled to the at least one battery 44 for charging the at least one battery 44. The charger 46 may comprise a solar panel that is coupled to the outer wall 22 of the housing 18 such that the solar panel is exposed to sunlight. The charger 46 may comprise a thermal scavenging charger 46 that generates electricity from heat scavenged from braking and heat scavenged from friction between the vehicle wheel 14 and the road.

In use, the driver actuates the valve unit 12 to release air pressure from the tire on the vehicle wheel 14 when the vehicle is driven on sand or other similar type of material. In this way the driver does not have to exit the vehicle to manually deflate the tire on the vehicle wheel 14. The driver actuates the valve unit 12 to inflate the tire on the vehicle wheel 14 to a pre-determined pressure when the vehicle is driven on a paved roadway or other hard surface. In this way the driver does not have to exit the vehicle to manually inflate the tire on the vehicle wheel 14. A plurality of the valve units 12 is provided and each of the valve units is coupled to a respective one of each of the vehicle wheels 14 that are on the vehicle.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wheel pressure adjustment assembly being configured to selectively inflate or deflate a wheel on a vehicle, said assembly comprising:
a valve unit being fluidly coupled to a vehicle wheel, said valve unit being actuatable in an open condition for passing air therethrough wherein said valve unit is configured to deflate the vehicle wheel, said valve unit being actuatable in a closed condition for inhibiting air from passing therethrough wherein said valve unit is configured to retain air pressure in the vehicle wheel at a selected pressure, said valve unit being actuatable into an inflating condition for passing air into the vehicle wheel; and
a compressor being coupled to said valve unit, said compressor being turned on when said valve unit is actuated into said inflating condition wherein said compressor is configured to inflate the vehicle wheel.

2. The assembly according to claim 1, wherein said valve unit comprises a stem and a housing, said stem having a distal end with respect to said housing, said distal end being open, said stem being hollow, said stem being coupled to the vehicle wheel having said housing being positioned within the vehicle wheel and having said distal end being exposed, said housing having an outer wall, said outer wall having vent extending into an interior of said housing.

3. The assembly according to claim 2, wherein said valve unit includes a control circuit being coupled to said housing of said valve unit, said control circuit receiving a deflate input, an inflate input and an off input.

4. The assembly according to claim 3, wherein:
said valve unit includes a valve being movably positioned in said stem of said valve unit, said valve being electrically coupled to said control circuit, said valve being fluidly coupled between said distal end of said stem and sand vent in said outer wall of said housing;
said valve is actuated into an open position when said control circuit receives said deflate input wherein said valve is configured to pass air in the vehicle wheel outwardly through said vent for deflating the vehicle wheel; and
said valve is actuated into a closed position when said control circuit receives said off input wherein said valve is configured to inhibit air in the vehicle wheel from passing outwardly through said vent.

5. The assembly according to claim 4, wherein said compressor is positioned in said housing, said compressor being electrically coupled to said control circuit, said compressor having an input and an output, said output being in fluid communication with said vent in said outer wall of said housing, said input being in fluid communication with said valve, said compressor pumping air inwardly through said input and outwardly through said output, said compressor being turned on when said control circuit receives said inflate input, said valve being urged into said open position by air pressure when said compressor is turned on wherein said compressor is configured to inflate the vehicle wheel.

6. The assembly according to claim 3, wherein said valve unit includes a pressure sensor being positioned in said housing, said pressure sensor being electrically coupled to said control circuit, said pressure sensor being in fluid communication with said valve wherein said pressure sensor is configured to sense air pressure within the vehicle wheel.

7. The assembly according to claim 3, wherein said valve unit includes a transceiver being positioned in said housing, said transceiver being electrically coupled to said control circuit, said transceiver being in wireless communication with an electronic control system of the vehicle.

8. The assembly according to claim 7, wherein said control circuit receives said inflate input when a driver of the vehicle actuates the electronic control system to inflate the vehicle wheel.

9. The assembly according to claim 8, wherein said control circuit receives said deflate input when the driver actuates the electronic control system to deflate the vehicle wheel.

10. The assembly according to claim 9, wherein said control circuit receives said off input when the driver actuates the electronic control system to retain the vehicle wheel at the current air pressure, said transceiver communicating the air pressure sensed in the vehicle wheel to the electronic control system for informing the driver of the air pressure within the vehicle wheel.

11. The assembly according to claim 3, further comprising a power supply being coupled to said housing, said power supply being electrically coupled to said control circuit, said power supply comprising:
at least one battery being positioned in said housing, said at least one battery being electrically coupled to said control circuit; and
a charger being coupled to said outer wall of said housing such that said charger is exposed, said charger being electrically coupled to said at least one battery for charging said at least one battery.

12. A wheel pressure adjustment assembly being configured to selectively inflate or deflate a wheel on a vehicle, said assembly comprising:
a valve unit being fluidly coupled to a vehicle wheel, said valve unit being actuatable in an open condition for passing air therethrough wherein said valve unit is configured to deflate the vehicle wheel, said valve unit being actuatable in a closed condition for inhibiting air from passing therethrough wherein said valve unit is configured to retain air pressure in the vehicle wheel at a selected pressure, said valve unit comprising a stem and a housing, said stem having a distal end with respect to said housing, said distal end being open, said stem being hollow, said stem being coupled to the vehicle wheel having said housing being positioned within the vehicle wheel and having said distal end being exposed, said housing having an outer wall, said outer wall having vent extending into an interior of said housing;
a control circuit being coupled to said housing of said valve unit, said control circuit receiving a deflate input, an inflate input and an off input;
a valve being movably positioned in said stem of said valve unit, said valve being electrically coupled to said control circuit, said valve being fluidly coupled between said distal end of said stem and sand vent in said outer wall of said housing, said valve being actuated into an open position when said control circuit receives said deflate input wherein said valve is configured to pass air in the vehicle wheel outwardly through said vent for deflating the vehicle wheel, said valve being actuated into a closed position when said control circuit receives said off input wherein said valve is configured to inhibit air in the vehicle wheel from passing outwardly through said vent;
a compressor being positioned in said housing, said compressor being electrically coupled to said control circuit, said compressor having an input and an output, said output being in fluid communication with said vent in said outer wall of said housing, said input being in fluid communication with said valve, said compressor urging air inwardly through said input and outwardly through said output, said compressor being turned on when said control circuit receives said inflate input, said valve being urged into said open position by air pressure when said compressor is turned on wherein said compressor is configured to inflate the vehicle wheel;
a pressure sensor being positioned in said housing, said pressure sensor being electrically coupled to said control circuit, said pressure sensor being in fluid communication with said valve wherein said pressure sensor is configured to sense air pressure within the vehicle wheel;
a transceiver being positioned in said housing, said transceiver being electrically coupled to said control circuit, said transceiver being in wireless communication with an electronic control system of the vehicle, said control circuit receiving said inflate input when a driver of the vehicle actuates the electronic control system to inflate the vehicle wheel, said control circuit receiving said deflate input when the driver actuates the electronic control system to deflate the vehicle wheel, said control circuit receiving said off input when the driver actuates the electronic control system to retain the vehicle wheel at the current air pressure, said transceiver communicating the air pressure sensed in the vehicle wheel to the electronic control system for informing the driver of the air pressure within the vehicle wheel; and
a power supply being coupled to said housing, said power supply being electrically coupled to said control circuit, said power supply comprising:
at least one battery being positioned in said housing, said at least one battery being electrically coupled to said control circuit; and
a charger being coupled to said outer wall of said housing such that said charger is exposed, said charger being electrically coupled to said at least one battery for charging said at least one battery.
